(19) United States
(12) Patent Application Publication
(10) Pub. No.: US 2006/0158424 A1
(43) Pub. Date: Jul. 20, 2006

(54) Optical slide pad

(76) Inventor: Tong Xie, San Jose, CA (US)

Correspondence Address: AVAGO TECHNOLOGIES, LTD., P.O. BOX 1920, DENVER, CO, 80201-1920, US

(21) Appl. No.: 11/040,021

(22) Filed: Jan. 19, 2005

(51) Int. Cl. G09G 5/00

(52) U.S. Cl. 345/156

(57) ABSTRACT

An input device includes a movable pad within a frame, a first linear array of optical sensors located opposite the movable pad, and a second linear array of optical sensors located opposite the movable pad. The first and the second linear arrays are arranged along different axes and generate signals in response to light from a surface on the movable pad. The input device further includes a processor coupled to the arrays to receive the signals. The processor determines a motion of the movable pad from the signals. The processor may translate the motion of the movable pad into a motion of a cursor on a display.

### DESCRIPTION OF RELATED ART

Various input devices are in use for manipulating icons such as cursors on screens of computers and various electronic devices. For example, computer mice and trackballs are popular as input devices for desktop computers.

For personal digital assistants (PDAs) and cellular telephones, touch sensitive pads, joystick controls, and push buttons are popular. However, each of these devices has drawbacks. For example, touch pads require a relatively large input area. In small devices such as cellular telephones, surface area is at a premium. Joystick controls have poor user feedback. This is because joystick controls typically do not move at all; rather, pressure sensors are used to detect user input. Push buttons allow movements only in discrete directions rather than movements in all directions.

### SUMMARY

In one embodiment of the invention, an input device includes a movable pad within a frame, a first linear array of optical sensors located opposite the movable pad, and a second linear array of optical sensors located opposite the movable pad. The first and the second linear arrays are arranged along different axes and generate signals in response to light from a surface on the movable pad. The input device further includes a processor coupled to the arrays to receive the signals. The processor determines a motion of the movable pad from the signals. The processor may translate the motion of the movable pad into a motion of a cursor on a display.

### BRIEF DESCRIPTION OF THE DRAWINGS

FIG. 1 is a schematic top view of an optical slide pad in one embodiment of the invention.

FIG. 2 is a schematic cross-section of the optical slide pad of FIG. 1 in one embodiment of the invention.

FIGS. 3 and 4 illustrate patterns provided on the surface of a slide pad in one embodiment of the invention.

FIG. 5 illustrates a block diagram of the optical slide pad in one embodiment of the invention.

Use of the same reference numbers in different figures indicates similar or identical elements.

### DETAILED DESCRIPTION

A new type of input device is disclosed in commonly assigned U.S. patent application Ser. No. 10/651,589, attorney docket no. 10021040-1, entitled “Finger Navigation System Using Captive Surface,” filed on Aug. 29, 2003. The input device includes a captive disc movably suspended over an optical navigation engine. The optical navigation engine detects movement of the captive disc by comparing successive images of the disc surface. The present invention improves upon the input device originally disclosed in U.S. patent application Ser. No. 10/651,589.

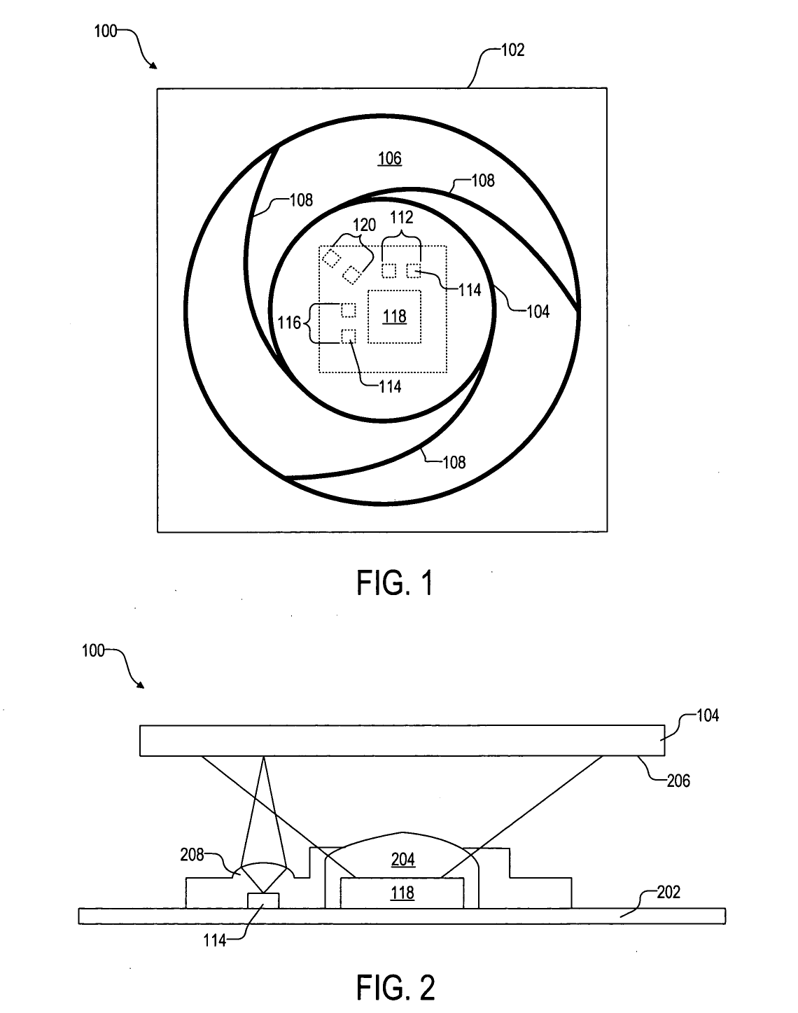

FIG. 1 illustrates a top view of an optical slide pad device 100 in one embodiment of the invention. Device 100 may be an interface for a portable device, such as a cell phone, a PDA, or a digital camera. A user may operate device 100 to move a cursor on a display of the portable device.

Optical slide pad device 100 includes a frame 102 and a slide pad 104 (also referred to as a movable pad) located within an opening 106 of frame 102. In one embodiment, slide pad 104 and opening 106 are both circular. Springs 108 attach slide pad 104 to frame 102. In one embodiment, springs 108 are spiral springs that attach in a tangential fashion to slide pad 104 and frame 102. Springs 108 return slide pad 104 to a center resting position within opening 106. In operation, a user places his or her finger on slide pad 104 to move the cursor.

An optical navigation engine 110 (shown in phantom in FIG. 1) is located below slide pad 104. Optical navigation engine 110 includes a linear array 112 of optical sensors 114 (only one is labeled for clarity) along a first axis, a linear array 116 of optical sensors 114 (only one is labeled for clarity) along a second axis orthogonal to the first axis, and a light source 118 for illuminating a bottom surface 206 (FIG. 2) of slide pad 104. In one embodiment, optical navigation engine 110 includes one or more additional linear arrays along one or more additional axes (e.g., a third linear array 120 oriented 45 degrees to linear arrays 112 and 116) to improve the precision of optical slide pad device 100. Thus, the present invention utilizes linear optical sensor arrays instead of the full 2-dimensional optical sensor array disclosed in U.S. patent application Ser. No. 10/651,589.

Optical sensors 114 can be CCD (charge coupled device) or CMOS (complimentary metal-oxide semiconductor) sensors. Light source 118 can be a coherent source (e.g., a laser diode or a vertical cavity surface emitting laser), a partially coherent source, or an incoherent light source (e.g., a light emitting diode, an electroluminescent light, or a fluorescent light). Optical sensors 114 generate electrical signals in response to light reflected from the bottom surface of slide pad 104.

FIG. 2 illustrates a cross-section of optical slide pad device 100 in one embodiment. Optical sensors 114 (only one is visible) and light source 118 are located on a substrate 202. A lens 204 is located above light source 118 to create a desired intensity pattern over bottom surface 206 of slide pad 104. In another embodiment, lens 204 is not necessary and light source 118 naturally emits light with the desired intensity pattern over bottom surface 206. Micro-lenses 208 are placed above optical sensors 114 to create images of bottom surface 206 on optical sensors 114. In another embodiment, micro-lenses 208 may be replaced with a single lens. In yet another embodiment, lenses 208 are not necessary and reflected light from bottom surface 206 is directly collected by optical sensors 114. Lenses 202 and 208 can be replicated, reflowed, transfer molded, or etched at the wafer level to produce a compact device with very low manufacturing cost.

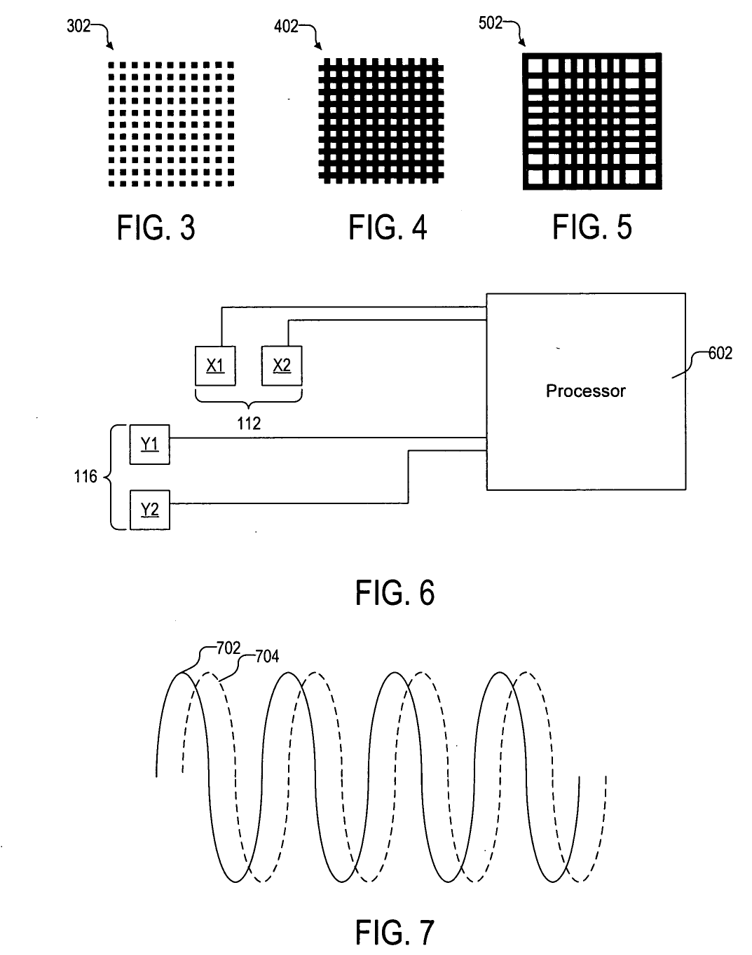

Bottom surface 206 has a repetitive pattern that can be resolved by a processor 602 (FIG. 6) coupled to sensor arrays 112 and 116 to determine the motion of slide pad 104. FIGS. 3 to 5 illustrate various repetitive patterns that can be textured or printed on bottom surface 206.

FIG. 3 illustrates a repetitive pattern 302 on bottom surface 206 in one embodiment of the invention. Pattern 302 consists of light horizontal and vertical lines over a dark background.

FIG. 4 illustrates a repetitive pattern 402 on bottom surface 206 in one embodiment of the invention. Pattern 402 consists of dark horizontal and vertical lines.

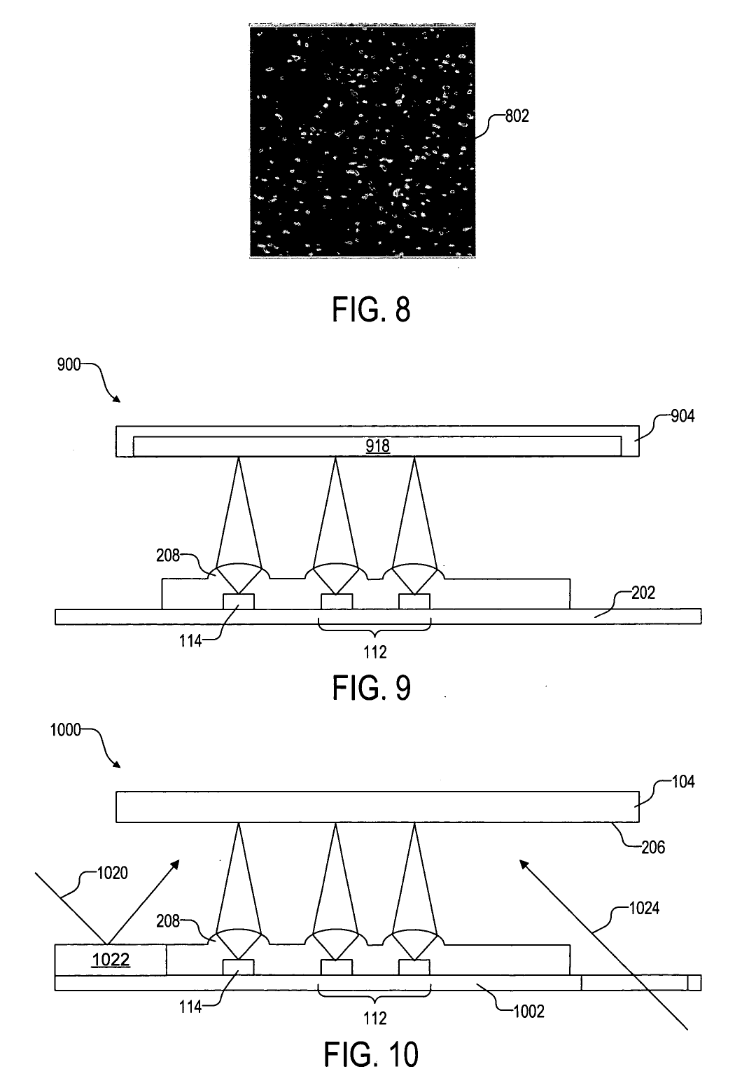

FIG. 5 illustrates another repetitive pattern 502 on bottom surface 206 in one embodiment of the invention. Pattern 502 is similar to pattern 402 except that the spacing between the lines is not uniform. Instead, the spacing increases as the lines approach the edges of pattern 502. The increasing spacing may be used to detect when slide pad 104 is near the edge of opening 106. Thus, pattern 502 has different periodicities at different regions of bottom surface 206.

FIG. 6 illustrates a block diagram of optical engine 110 in one embodiment of the invention. Processor 602 is coupled to the optical sensors in arrays 112 and 116. The optical sensors in array 112 consist of at least two elements individually labeled as X1 and X2. The two sensors are positioned to generate electronic signals that are 90 degrees out of phase. Similarly, the optical sensors in array 116 include at least two elements that are individually labeled as Y1 and Y2 and positioned with 90 degrees phase difference.

As slide pad 104 moves in the 2-dimensional plane over optical navigation engine 110, sensor arrays 112 and 116 observe the repetitive patterns on slide pad surface 206 and generate corresponding electrical signals. For example, FIG. 7 illustrates a signal 702 generated by sensor array 112. Processor 602 uses the electrical signals to determine the displacement of slide pad 104 along the axes of sensor arrays 112 and 116. For example, processor 602 can count the number of bright or dark fringes observed in the signal 702. Signal processing required to derive relative motion is similar to the one used in a conventional incremental encoder. Each sensor array must contain at least two optical sensors 114 in order to derive both displacement and the direction of the motion along the sensor axis. In one embodiment, two optical sensors 114 are spaced to receive signals that are 90 degrees out of phase so the direction of the motion can be determined from the phase relationship between the received signals at each optical sensor 114.

It is noted that at least two optical sensors 114 are provided along each axis for quadrature detection. When more than two optical sensors 114 are used, signals from nonadjacent optical sensors along the same axis are observed over time and used to determine the direction in which slide pad 104 travels. For example, a first nonadjacent pair and a second nonadjacent pair are observed over time to detect signals 702 and 704 (FIG. 7) that indicate the direction in which slide pad 104 travels.

Processor 602 translates the displacement of slide pad 104 into a cursor displacement. In one embodiment, processor 602 directly maps the displacement of slide pad 104 into a cursor displacement. In one embodiment using pattern 502, processor 602 increases the displacement of the cursor when the periodic signals observed sensor arrays 112 and 114 increase.

In one embodiment of the invention described above, a coherent light source (e.g., a vertical cavity surface emitting laser) is used to provide illumination to bottom surface 206 of slide pad 104. In that embodiment, bottom surface 206 is non-optical flat so that the coherent illumination of the optically rough surface results in speckle patterns. FIG. 8 illustrates an exemplary speckle pattern 802. Sensor arrays 112 and 114 capture these speckle patterns with or without the help of lenses. The captured speckle patterns contain bright and dark spots with an average speckle size that is a function of the wavelength, illumination spot size, and the distance between the slide pad and the sensor. The speckle patterns are nearly repetitive so that the motion of the slide pad can be determined from tracking the motion of the speckle patterns using the same processing algorithm described above for counting fringes.

FIG. 9 illustrates a cross-section of an optical slide pad device 900 in one embodiment of the invention. Device 900 is similar to device 100 (FIGS. 1 and 2) except light source 118 (FIGS. 1 and 2) is replaced with alternative light sources. In one embodiment, a light source 918 is integrated into a slide pad 904 to generate the repetitive pattern detected by optical sensors 114. Light source 918 may be patterned to produce the desired periodic pattern for motion detection, or it may be used as back light to illuminate a patterned surface as part of the slide pad 904. In another embodiment, slide pad 904 is a self-illuminated material (e.g. electro-luminescent sheet) that generates the desired repetitive pattern. The self-illuminated slide pad 904 may be patterned to generate the repetitive pattern or be used as back light of a patterned sheet that overlays slide pad 904.

FIG. 10 illustrates a cross-section of an optical slide pad device 1000 in one embodiment of the invention. Device 1000 is similar to device 100 except that ambient light is used to illuminate slide pad 104. Ambient light may be introduced within device 1000 in many ways. In one embodiment, ambient light 1020 enters from top openings in the housing of device 1000 and is directed by an optical component 1022 (e.g., a mirror) onto bottom surface 206 of slide pad 104. In another embodiment, ambient light 1024 enters from bottom openings in the housing and onto bottom surface 206. Although not illustrated, ambient light may enter from the side of device 1000 and onto bottom surface 206. Furthermore, any combination of the lighting schemes may be used.

As can be seen, a very small input device having a low profile can be achieved. This is attributable to micro optics produced at the wafer level and the integration of optical sensors, light source, and processor on the same substrate. The device can be produced at very low cost, as the motion calculation can be accomplished with simple electronics and requires minimal computation.

Various other adaptations and combinations of features of the embodiments disclosed are within the scope of the invention. Numerous embodiments are encompassed by the following claims.

What is claimed is:

1. An input device, comprising:
a movable pad within a frame;
a first linear array of optical sensors located opposite the movable pad;
a second linear array of optical sensors located opposite the movable pad, wherein the first and the second linear arrays are aligned along different axes and the first and the second linear arrays generate signals in response to light from a surface of the movable pad.

2. The input device of claim 1, wherein the surface has a repetitive pattern that is spaced evenly apart.

3. The input device of claim 1, wherein the surface has a repetitive pattern with different periodicities at different regions of the surface.

4. The input device of claim 1, wherein the movable pad is attached by at least one spring to the frame.

5. The input device of claim 1, further comprising:
a processor coupled to the first and the second linear arrays to receive the signals, the processor determining a motion of the movable pad from the signals.

6. The input device of claim 5, wherein:
the processor determines a first displacement of the movable pad along the first linear array by counting fringes in the signals from the first linear array;
the processor determines a second displacement of the movable pad along the second linear array by counting fringes in the signals from the second linear array.

7. The input device of claim 5, wherein:
the first and the second linear arrays each comprises at least two optical sensors;
the processor determines a first direction of a first displacement of the movable pad by observing over time the signals of the optical sensors in the first linear array;
the processor determines a second direction of a second displacement of the movable pad by observing over time the signals of the optical sensors in the second linear array.

8. The input device of claim 1, further comprising:
optical lenses located over the optical sensors for creating images of the surface of the movable pad on the first and the second linear arrays.

9. The input device of claim 5, further comprising:
a light source located opposite the surface of the movable pad, the light source illuminating the surface.

10. The input device of claim 9, wherein the light source is selected from the group consisting of a coherent light source, a partially coherent light source, and an incoherent light source.

11. The input device of claim 9, further comprising:
an optical lens located over the light source for generating a intensity pattern over the surface.

12. The input device of claim 9, wherein the light source is a coherent light source and the surface is non-optical flat.

13. The input device of claim 12, wherein the optical sensors in the first and the second linear arrays capture speckle patterns from the surface and the processor determines a motion of the movable pad from the speckle patterns.

14. The input device of claim 1, further comprising:
a third linear array of optical sensors located opposite the movable pad, wherein the third linear array is aligned along a different axis than the first and the second linear arrays, and the third linear array generates signals in response to light from the surface.

15. The input device of claim 1, wherein the movable pad is self-illuminating.

16. The input device of claim 1, wherein the movable pad comprises a light source.

17. The input device of claim 1, further comprising a housing defining an opening for allowing ambient light to enter and reflect from the surface of the movable pad.

18. The input device of claim 17, further comprising an optic for directing the ambient light onto the surface of the movable pad.
